(19) United States
(12) Patent Application Publication
(10) Pub. No.: US 2004/0051066 A1
(43) Pub. Date: Mar. 18, 2004

(54) Biased actuators and methods

(76) Inventor: Oded E. Sturman, Woodland Park, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/659,989

(22) Filed: Sep. 11, 2003

Related U.S. Application Data
(60) Provisional application No. 60/410,676, filed on Sep. 13, 2002.

(51) Int. Cl. F16K 31/02

(52) U.S. Cl. 251/129.09

(57) ABSTRACT

Biased actuators having first and second magnetic members, a first electromagnetic coil, the first magnetic member being moveable relative to the second magnetic member between first and second positions, and being electromagnetically attracted to the first position by electrical excitation of the first electromagnetic coil, a first preloaded spring configured to apply a first spring force to the first magnetic member biasing the first magnetic member towards the second position only when the first magnetic member is in or between the first position and some fraction of its travel from the first position to the second position. Various embodiments are disclosed, including embodiments having a second spring acting as a return spring throughout the motion of the first magnetic member, and dual electromagnetic coil configurations. Exemplary embodiments are disclosed with respect to spool-type valves.

### CROSS-REFERENCE TO RELATED APPLICATION

This application claims the benefit of U.S. Provisional Patent Application No. 60/410,676 filed Sep. 13, 2002.

### BACKGROUND OF THE INVENTION

1. Field of the Invention

The present invention relates to the field of electromagnetic actuators and electromagnetic actuated fluid control valves.

2. Prior Art

Electromagnetic actuators of various designs are well known in the prior art. Such designs include single electromagnetic coil, spring return designs, dual electromagnetic coil designs with or without latching by residual magnetism, and dual electromagnetic coil designs with spring biasing of the actuator to a central position. Also known are long stroke, two position actuators having two bias mechanical springs in series urging the moving member to a known position. Because the two springs act in series, the two springs necessarily have the same preload, even though they may have different spring rates. In any event, on actuation, both springs begin to compress further as the moving member moves toward its actuated position. However, the junction between the two springs is specifically limited in its travel by an appropriately positioned stop. Consequently, at some point during the travel of the moving member, that stop is reached, after which only one spring is active. The net effect is not a step change in force on the moving member, but rather a step change in the spring rate. More particularly, if the two springs have the same spring rate, then the two springs in series will have one half the spring rate of each individual spring. Consequently, during the initial part of the travel of the movable member, the spring rate will be equal to one half the spring rate of an individual spring, though when the junction between the springs reaches its stop, one spring becomes inactive, though the force on the active spring doesn't instantly change stepwise. Instead, the spring rate from that point to full actuation of the moving member is now twice the initial spring rate of the two springs in series. The net result is said to be a shaping of the spring force to better approximate the nonlinear magnetic force generated by the electromagnetic actuator.

One application of the present invention of special interest is the application of the invention to fluid control valves, such as may be used, by way of example, as fluid control valves for hydraulically-actuated fuel injectors, hydraulically-actuated engine valves and the like. In such applications, it is frequently desired to use a spool valve having a two-position spool to couple an outlet or cylinder port to either a source of working fluid under pressure or to a drain, vent or relatively low pressure port. It is further often desired to have the spool seek a predetermined known position as a default position, usually a position coupling its outlet port to the drain port, when no electrical excitation is applied, both to provide a known starting point and as a failsafe feature. Finally, speed of operation is also important in such applications. The present invention provides a biased actuator having the foregoing desirable characteristics. Other desirable characteristics of the present invention include:

1. Conserve energy/improved efficiency (minimizes use of electrical current and stores reused energy);

2. Digital operation—either “on” or “of”;

3. Bias non-electrical force to help overcome stiction and return to non-actuated position;

4. Bias non-electrical force to help overcome opposing fluid force, if any, and return to non-actuated position; and,

5. Magnetic field in actuated position is easier/quicker to collapse and release spool from actuated position.

### BRIEF DESCRIPTION OF THE DRAWINGS

FIG. 1 is a cross section of one embodiment of a spool-type fluid control valve in accordance with the present invention.

FIG. 2 is a graph illustrating the spring forces acting on the spool of the embodiment of FIG. 1.

FIG. 3a is a cross section of another embodiment of a spool-type fluid control valve in accordance with the present invention.

FIG. 3b is a view taken on an expanded scale along line 3b-3b of FIG. 3a.

FIG. 4 is a cross section of another embodiment of a spool-type fluid control valve in accordance with the present invention.

FIGS. 5a, 5b and 5c are graphs illustrating the spring forces acting on the spool of the spool-type fluid control valve of FIG. 4.

### DETAILED DESCRIPTION OF THE PREFERRED EMBODIMENTS

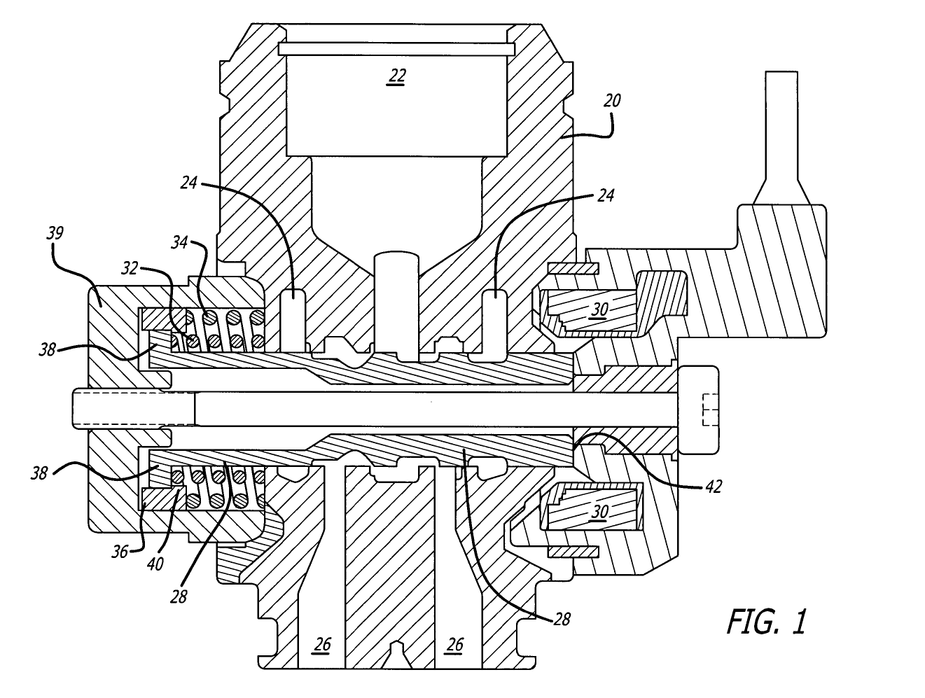

First referring to FIG. 1, an exemplary embodiment of the biased actuator of the present invention may be seen. As shown therein, this exemplary embodiment is a 2-position 3-way spool-type fluid control valve comprising:

a valve body 20 defining a first (e.g., supply) port 22, (one or more) second (e.g., vent or drain) port(s) 24, and (one or more) third (e.g., cylinder or outlet) port(s) 26;

a movable valve member (e.g., spool) 28 positioned in the valve body 20 and movable between a first (e.g., vented or leftmost seated) position and a second (e.g., supply or rightmost seated as shown) position;

a single electromagnetic coil 30;

first spring 32 (relatively lightly preloaded spring);

second spring 34 (relatively more heavily preloaded spring having a spring rate equal to or different than the first spring); and a retainer 36.

The third (e.g., cylinder) port(s) may, for example, be adapted to communicate with an intensifier or plunger of a hydraulically-actuated fluid injector, or a hydraulically-actuated engine valve, or some other device.

In the first or leftmost position, the spool 28 opens fluid communication between the third (e.g., cylinder) and the second (e.g., vent) port(s) while blocking fluid communication between the first (e.g., supply) port and the third (e.g., cylinder) port(s). Only the first spring 32 acts on the spool 28 when the spool is at the first or leftmost position and the first spring 32 continues to act on the spool 28 during a predetermined first displacement of the spool 28 away from its first position (e.g., from about 0 to 0.015 inches displacement to the right in one exemplary embodiment).

Also, throughout a predetermined intermediate displacement (e.g., from 0 to about 0.007 inches) of the spool 28 away from the first position, the first port 22 is blocked and the one or more second (e.g., vent) port(s) 24 communicate with the respective one or more third (e.g., cylinder) port(s) 26.

At the predetermined first displacement away from the first position (e.g., about 0.015 inches), the spool 28 engages the retainer 36. At this point, both the first 32 and second 34 springs oppose (but do not prevent) further displacement of the spool 28 away from its first position (e.g., in the range of about 0.015 to 0.020 inches relative to the first position). At a predetermined second displacement of the spool away from its first position (e.g., about 0.020 inches away from the first position), the spool abuts a stop 42 and assumes its second position, preferably but not necessarily with a zero or substantially zero nonmagnetic air gap in the magnetic circuit. At the second or rightmost position of the spool 28, the first (e.g., supply) port is in fluid communication with the third (e.g., cylinder) port(s) and fluid communication is blocked between the second (e.g., vent) port(s) and the third (e.g., cylinder) port (s).

Thus in this embodiment, with no electrical current applied to the coil 30, the spool 28 (or other valve element) (ultimately) assumes its first (e.g., vent or leftmost seated) position and is biased there by only a first spring 32 having a relatively lower preload. When the coil 30 is electrically energized, the spool 28 is electromagnetically attracted toward its second (e.g., supply or rightmost seated) position shown, initially against only an opposing force of the first spring 32. As the moving spool 28 reaches a predetermined (partial) displacement away from its first (e.g., vent) position, a shoulder 38 on the spool 28 engages a corresponding shoulder 40 on the retainer 36 associated with the second spring 34 having the relatively higher preload. The moving spool 28 is now subject to the combined opposing action of the first 32 and second 34 springs. However, at this point, the momentum of the moving spool and the magnitude of the electromagnetic attraction pulling the spool towards the pole piece or end cap of the coil 30 are sufficient to overcome the combined opposing forces of the first 32 and second 34 springs. As the springs 32,34 are compressed by the moving spool 28, energy is being stored in the compressed springs as recoverable potential energy. In that regard, the nonmagnetic air gap in the magnetic circuit defined in part by the spool 28 and the pole piece of the coil 30 has decreased substantially, resulting in a high magnetic force even if the electrical current in coil 30 is maintained constant or even may have been reduced. Also, generally the two springs are preloaded, so that the change in spring force of either spring with spool travel normally is not very much, given the relatively small changes in spring compression due to spool 28 travel.

In the preferred form, the nonmagnetic air gap is zero when the spool 28 is at its second position. Moreover, the magnetic circuit is saturated to maximize hysteresis. Moreover, the combined forces of the two springs 32 and 34 exceed the holding force provided by the hysteresis of the magnetic parts. Thus a relatively small holding electrical current is required in the coil 30 to augment the hysteresis and collectively maintain the spool 28 at its second (e.g., supply) position against the combined opposing forces of the first and second springs. (Alternatively, in this and in other embodiments, by proper selection of the spring forces and the magnetic materials, the spool could be made to latch at the actuated position with residual magnetism and no electrical current.) Preferably the magnetic circuit does not include any permanent magnets, but rather other magnetic materials such as 8620, 440C, 4140 or 52100 steel for good wear and other properties, or other magnetic materials such as, by way of example, hot or cold rolled 1020 steel. Still other magnetic materials may also be used for a specific application in question as desired.

When the electrical current is discontinued through the coil 30, the (unbalanced) combined forces of the compressed first 32 and second 34 springs rapidly accelerate the spool 28 toward its first (e.g., vent) position. At a predetermined (partial) displacement of the spool 28 away from its second (e.g., supply) position, the retainer 36 abuts end cap 39. The shoulder 38 of the (leftward) moving spool 28 then separates from the corresponding shoulder 40 of the stopped retainer 36 (and therefore the spool separates from the action of the second spring) and the spool continues to move toward its first (e.g., vent) position under the force of the first spring 32 only until seating against a stop.

If magnetic latching is used, then a non-magnetizing electrical pulse is required to release the magnetically latched spool. Non-latching valves may be preferred for many applications, however, as that allows the use of a higher spring force for the spring 34. This allows spring 34 to store more energy from the moving spool 28 as it approaches the limit of its travel, providing a more rapid acceleration of the spool towards the first position when the electrical current in coil 30 is terminated. Also, while a holding electrical current is needed if latching by residual magnetism is not used, that holding current may be relatively small compared to the initial actuation current, as the non-magnetic gap in the magnetic circuit is normally small when the spring 34 becomes active, and is zero or substantially zero once the spool reaches the limit of its actuated travel.

The foregoing is one exemplary embodiment only. The same concepts are applicable to two position valves, preferably spool-type valves, of different porting, as well as two position valves, preferably spool-type valves, of two-way and four-way configurations, to name but a few alternative applications of the invention. It may also be applicable to dual electromagnetic coil, 3-position fluid control valves (e.g., two opposing electromagnetic coils, two relatively highly preloaded springs with lost motion in either direction from an intermediate position, and two relatively lower preloaded springs or other device for non-electrically biasing the spool to an intermediate position).

Thus, one aspect of the present invention as applied to spool-type control valves is the use of a spring return spool actuated by excitation of a single electromagnetic coil, preferably using one relatively lightly preloaded spring active over the entire travel of the spool for return of the spool to the non-actuated position, and a relatively highly preloaded spring active over only the final motion of the spool toward the actuated position to store energy particularly in the relatively highly preloaded spring. Thus the relatively lightly preloaded spring may be selected to be adequate to hold the spool in the non-actuated position, but not so high a preload (and spring rate) as to significantly slow the initial spool motion when the electromagnetic coil is electrically energized. The relatively highly preloaded spring is in turn configured to not be active until the valving change is nearing completion or is complete, and is preferably selected to store as much energy as possible while still reliably allowing completion of the spool motion and holding of the spool in the actuated position until the holding electrical current is terminated.

It should be noted that while preferably the spring that is active only over part of the travel of the spool is more highly preloaded than the spring that is active over the entire travel of the spool, this is not a specific limitation of the invention. Also, in the preferred embodiments, the spool travel is relatively small compared to the spring deflections from the preloading, so that the spring force does not vary that much over the range of spool travel. In any application, and particularly in other designs and other applications, such as applications wherein the moveable member has a larger stroke, one may chose the combination of spring rate and preload for optimum performance.

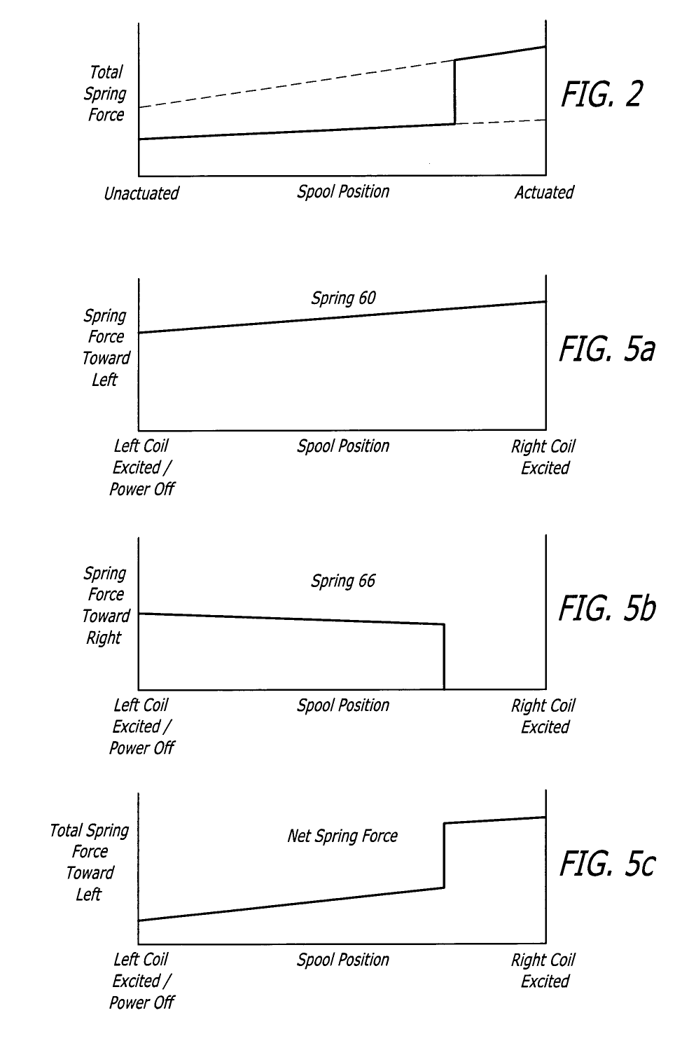

Now referring to FIG. 2, a graph illustrating the spring forces generally in accordance with the embodiment of FIG. 1 may be seen. The lower line represents the force or force component of spring 32, the spring that is active throughout the entire travel of the spool. The difference between the upper and lower lines represents the spring force of spring 34, which is active only near the actuated position (hence, the lower dashed line indicating what the spring force of spring 34 would be if active in that area). The combined force is indicated by the solid line, indicating a step change in total spring force near the actuated position as hereinbefore described. Note that the instantaneous step in the total spring force will occur, whether the two springs have the same or a different spring rate and/or are preloaded by the same or by different preloads. In that regard, the spring rates affect the slope of the lines in the graph, whereas the preload affects the vertical position of the lines on the graph, the preload of spring 34 determining the size of the step in the total spring force.

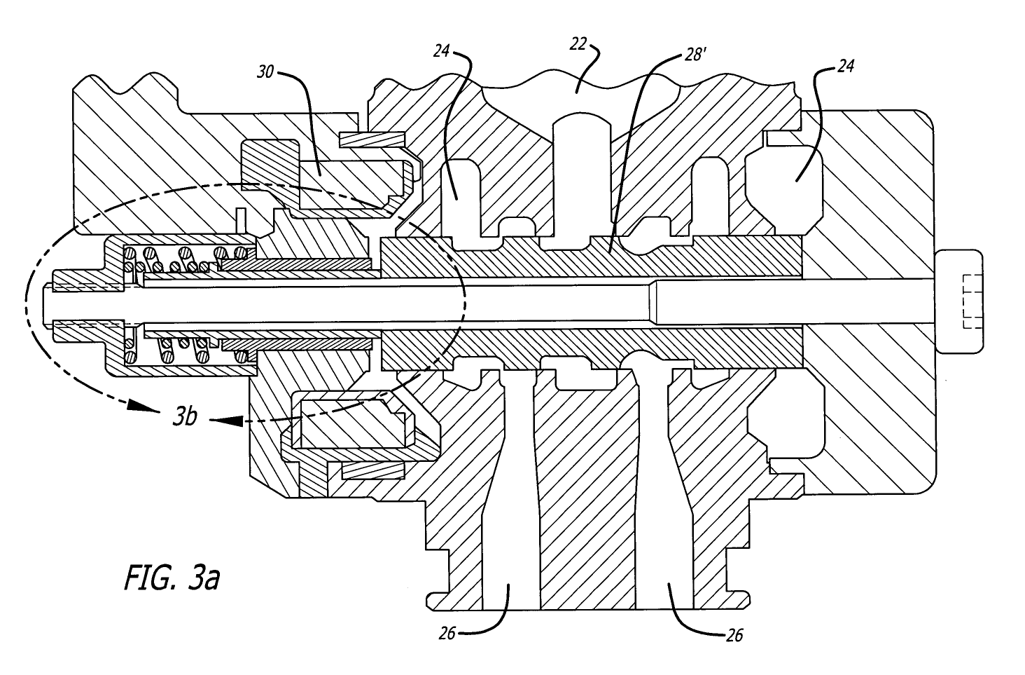

Now referring to FIGS. 3a and 3b, a cross-section of an alternate embodiment of the present invention may be seen. This valve, like the valve of FIG. 1, is a two-position, three-way spool-type fluid control valve having a spool 28′, a first (e.g., supply) port 22, one or more second (e.g., vent) ports 24 and one or more third (e.g., cylinder) ports 26. It also has a pair of return springs, one of which is active throughout the travel of the spool and the other of which is active only in the region of the actuated position, like the embodiment of FIG. 1. It differs from the embodiment of FIG. 1, however, in that the two springs and the electromagnetic coil 30 are positioned adjacent the same end of the spool 28′, rather than at opposite ends of the spool 28 as in the embodiment of FIG. 1. Also, since the electromagnetic coil has been moved to the same end of the spool as the springs, rather than vice versa, the actuated position for the spool is now the left-most position rather than the right-most position for the spool of FIG. 1.

In FIG. 3a, the right-most end of spool 28′ is shown as being flat and resting flat against the adjacent stop. This illustration is schematic only, in that preferably the end surface of the spool, or alternatively the surface of the stop against which it abuts when in the right-most position, is patterned so that the area of contact of the right-most end of the spool against the adjacent stop is a relatively small fraction of the total area of the end of the spool, thereby minimizing the suction effects upon actuation.

Details of the spring arrangement in the embodiment of FIG. 3a may be seen in FIG. 3b, showing a small region of FIG. 3a on an expanded scale. As shown therein, spool 28′ is illustrated in the unactuated position, the end of the spool 28′ being spaced away from pole piece 44, space 46 being free space for movement of the spool 28′ upon actuation of the electromagnetic coil 30. In this position, member 48 is pushing against the end of spring 28′ by the force of spring 50 acting against flange 52 integral with member 48. In this position, flange 52 is still spaced away from the end of member 54, members 52 and 54 being slidable longitudinally to the left against the resistance of springs 50 and 56, respectively. Spring 56 is pressing against flange 58 on member 48, which in turn is pressing against the end of pole piece 44 to keep the right end of member 54 extending slightly beyond the right-hand face of pole member 44, but spaced apart from the end of spool 28′. Thus only spring 50 is active to hold spool 28′ in its right-most unactuated position.

On actuation (excitation of electromagnetic coil 30), spool 28′ will be electromagnetically attracted toward the adjacent face of pole piece 44. This causes member 48 to slide to the left against the force of spring 50. When the face of spool 28′ engages the projection of member 54 in the region 46, member 54 will also be forced to slide to the left against the resistance of spring 56. Thus, as with the embodiment of FIG. 1, one spring is active as a return spring throughout the entire travel of the spool to the actuated position, whereas the second spring only becomes active as the spool approaches the actuated position, at which point there is a sudden increase in the total spring force and increase in the spring rate encountered by the spool.

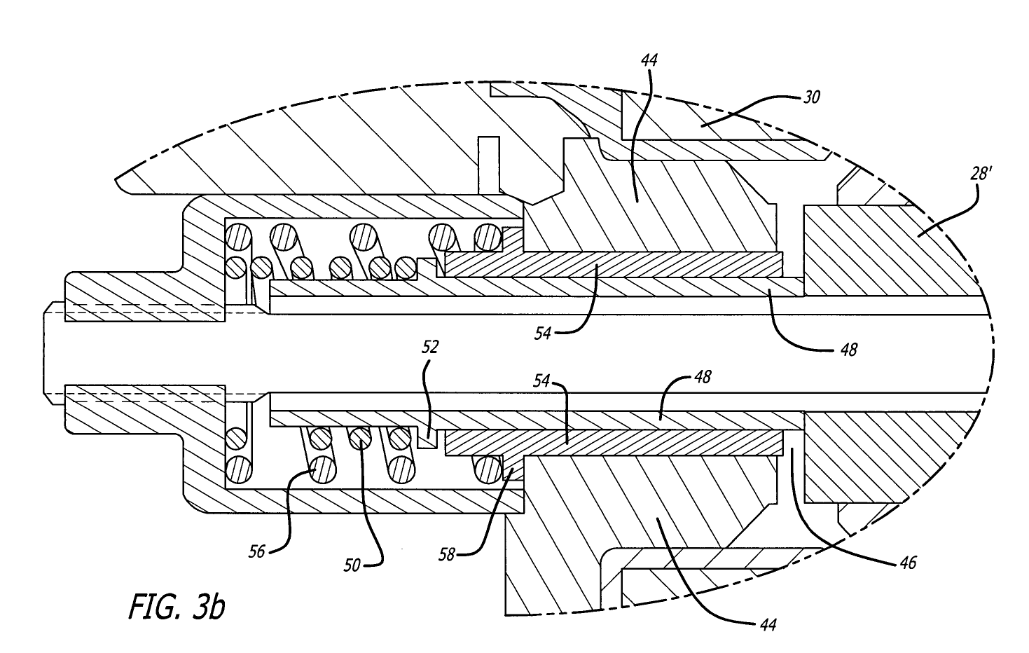

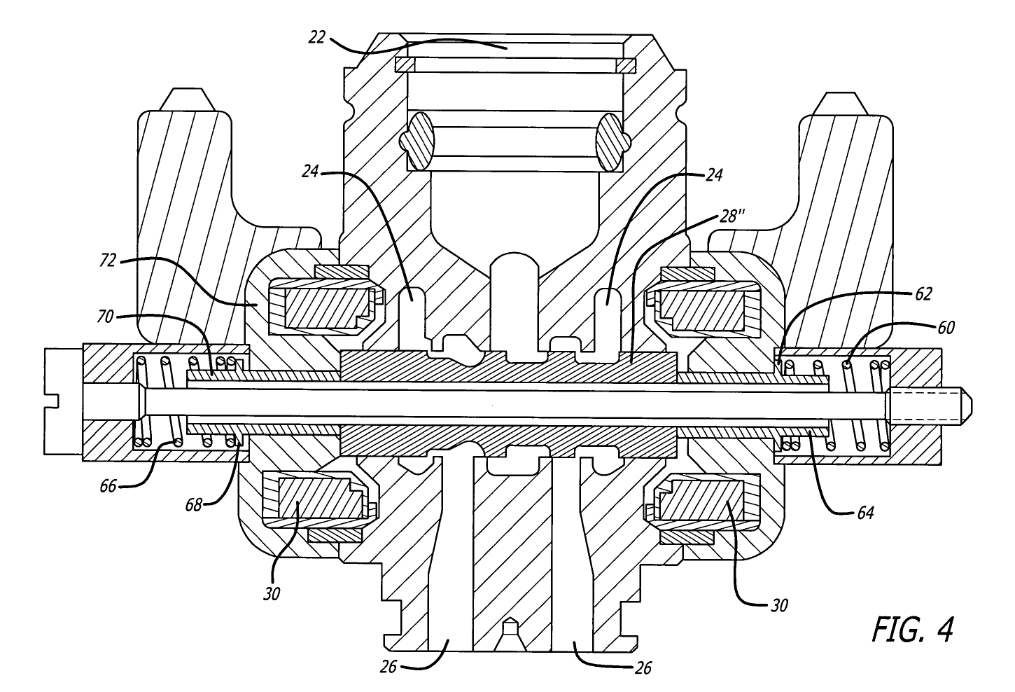

Now referring to FIG. 4, a still further alternate embodiment of the present invention may be seen. While the prior two embodiments had both springs at the same end of the spool, the embodiment of FIG. 4 has one spring at each end of the spool. This embodiment also uses two electromagnetic coils, one at each end of the spool, though as shall subsequently be seen, embodiments of this configuration having only a single electromagnetic coil may also be used. FIG. 4 illustrates the stable intermediate position of spool 28″ when neither electromagnetic coil 30 is electrically actuated. It also illustrates the spool 28″ in the position it would reach when the left electromagnetic coil 30 is electrically actuated. In this position, spring 60, acting against flange 62 on member 64, pushes member 64 and spool 28″ to their left-most position, with the left end of the spool resting against the face of the left pole piece 72 against the resistance of spring 66, acting against flange 68 on member 70. For this to happen, of course, spring 60 needs a higher spring force than spring 66. This is illustrated in FIGS. 5a and 5b. Also illustrated in FIG. 5b is the fact that at some point in the travel of the spool toward its right-most position upon actuation of the right electromagnetic coil 30, flange 68 on member 70 will engage the adjacent end of pole piece 72, and is thereafter not active in encouraging the spool to the right-most position. Thus the spool is subject to the force of spring 66 throughout much of its travel, such as by way of example, 75% of its travel to the right-most position, though thereafter imparts no force to the spool. Therefore the net spring force on the spool throughout much of its travel is the difference between the force of spring 60 and that of spring 66, though as the spool approaches the right-most actuated position, spring 66 is no longer active, so that the net spring force becomes the full spring force of spring 60 toward the left. This is illustrated in FIG. 5c, which is merely a graph of the difference in values graphed in FIGS. 5a and 5b. The overall result is similar to that illustrated in FIG. 2 for the embodiment of FIG. 1, though is achieved by using two springs opposing each other throughout most of the travel of the spool as opposed to two springs aiding each other but only adjacent the actuated position. Alternatively, in the embodiment of FIG. 4, the left electromagnetic coil could be left out, resulting in a single actuator, spring return spool valve having excitation requirements and operating characteristics that could be substantially identical to that of the embodiment of FIG. 2. The additional electromagnetic coil, however, has the beneficial effect of increasing the speed of operation of the spool-type fluid control valve, for example, towards the first or vent position. In the case of a fuel injector, for example, this can help control relatively small quantities of fuel injection. As a further alternative, one of the springs, specifically the return spring could be eliminated, with the return being achieved by the second electromagnetic coil.

Referring again to FIGS. 5a through 5c, the slopes of the lines in FIGS. 5a and 5b represent the spring rates of springs 60 and 66, respectively, whereas the height of each line indicates the preload on the respective spring. Accordingly, springs 60 and 66 could have the same spring rate, but with spring 60 being more heavily preloaded, in which case the net spring force in the region where both springs are active would have zero slope. In fact, that region could be given an opposite slope if spring 60 had a relatively lower spring rate than spring 66 but was so preloaded as to still exhibit a relatively higher spring force than spring 66.

The basic method of the present invention, no matter how implemented, is to preferably to provide a spring return over the full travel of the moveable valve member of an electromagnetic actuator, aided by the force of an additional spring as the movable member of the actuator approaches an actuated position, and wherein both springs may be preloaded as desired. (A return spring is not necessary if predetermination of the position of the moveable member is not required.) The preloading of the springs is desirable, particularly in applications wherein speed of operation is important, as it allows the moveable valve member to move quickly toward the actuated position, typically completing or nearly completing its intended function, whether as a valve or as some other electromagnetic actuator function, before encountering the second, preloaded spring. This allows fast action, debouncing of the moveable valve member and storage of energy into reusable potential energy for return to the moveable valve member on its release to the opposite position. In that regard, note that while certain specific embodiments have been disclosed herein, many other embodiments may be realized. By way of example, one might use an electromagnetic coil at each end of the spool, with a preloaded spring at each end of the spool, each preloaded spring being active for less than 50% of the spool travel, such as perhaps 20% to 25% of the spool travel. Such a device would not have a predefined rest position, though in applications where that is not important, could have other advantageous properties. Also other types of springs may be used, and of course the invention may be generally applied to electromagnetic actuators in general, not just spool-type fluid control valves, as will be apparent to those of ordinary skill in the art. Further, the specific embodiments disclosed herein have a zero or substantially zero nonmagnetic air gap when in an actuated position. This is desirable though not essential for the practice of the present invention.

Thus while certain preferred embodiments of the present invention have been disclosed herein, such disclosure is only for purposes of understanding the exemplary embodiments and not by way of limitation of the invention. It will be obvious to those skilled in the art that various changes in form and detail may be made in the invention without departing from the spirit and scope of the invention as set out in the full scope of the following claims.

What is claimed is:

1. An electromagnetic actuator, comprising:
first and second magnetic members;
a first electromagnetic coil;
the first magnetic member being moveable relative to the second magnetic member between first and second positions, and being electromagnetically attracted to the first position by electrical excitation of the first electromagnetic coil; a first preloaded spring configured to apply a first spring force to the first magnetic member biasing the first magnetic member towards the second position only when the first magnetic member is in or between the first position and some fraction of its travel from the first position to the second position.

2. The actuator of claim 1, further comprised of a second preloaded spring configured to apply a second spring force to the first magnetic member biasing the first magnetic member towards the second position when the first magnetic member is in or anywhere between the first and second positions.

3. The actuator of claim 2, wherein the actuator requires a holding electrical current in the first electromagnetic coil to maintain the first magnetic member in the first position.

4. The actuator of claim 2, wherein the first magnetic member will magnetically latch in the first position by residual magnetism, without use of a holding electrical current.

5. The actuator of claim 2, wherein the actuator has first and second ends, and wherein the first electromagnetic coil and the first and second preloaded springs are adjacent the first end of the actuator.

6. The actuator of claim 2, wherein the actuator has first and second ends, and wherein the first electromagnetic coil is adjacent the first end of the actuator and the first and second preloaded springs are adjacent the second end of the actuator.

7. The actuator of claim 2, wherein the first and second preloaded springs are adjacent opposite ends of the actuator.

8. The actuator of claim 1, further comprised of a second electromagnetic coil, the first magnetic member being electromagnetically attracted to the second position by electrical excitation of the second electromagnetic coil.

9. The actuator of claim 8, further comprised of a second preloaded spring configured to apply a second spring force to the first magnetic member biasing the first magnetic member towards the second position when the first magnetic member is in or anywhere between the first and second positions.

10. The actuator of claim 9, wherein the fraction is less than approximately one half.

11. The actuator of claim 9, wherein the fraction is in the range of approximately one fifth to approximately one fourth.

12. The actuator of claim 1, wherein the actuator has a zero nonmagnetic gap when the first magnetic member is in the first position.

13. The actuator or claim 12, wherein the first magnetic member is a spool of a spool-type fluid control valve.

14. A spool-type fluid control valve, comprising:
a magnetic spool and a magnetic spool valve housing, the spool being moveable relative to the housing between first and second positions;
a first electromagnetic coil disposed in the housing and operable to electromagnetically attract the spool to the first position upon electrical excitation of the first electromagnetic coil;
a first preloaded spring configured to apply a first spring force to the spool biasing the spool towards the second position only when the spool is at any of i) the first position, ii) anywhere between the first position and some fraction, less than one, of its travel from the first position to the second position, and iii) the fraction of its travel from the first position to the second position.

15. The spool-type fluid control valve of claim 14, further comprised of a second preloaded spring configured to apply a second spring force to the spool biasing the spool towards the second position when the spool is at any of i) the first position, ii) the second position, and iii) anywhere between the first and second positions.

16. The spool-type fluid control valve of claim 15, wherein the spool valve requires a holding electrical current in the first electromagnetic coil to maintain the spool in the first position in opposition to the first and second spring forces of the first and second preloaded springs.

17. The spool-type fluid control valve of claim 15, wherein the spool will magnetically latch in the first position by residual magnetism, without continuous use of a holding electrical current in the first electromagnetic coil, in opposition to the first and second spring forces of the first and second preloaded springs.

18. The spool-type fluid control valve of claim 15, wherein the spool has first and second ends, and wherein the first electromagnetic coil and the first and second preloaded springs are located adjacent the first end of the spool.

19. The spool-type fluid control valve of claim 15, wherein the spool has first and second ends, and wherein the first electromagnetic coil is located adjacent the first end of the spool and the first and second preloaded springs are located adjacent the second end of the spool.

20. The spool-type fluid control valve of claim 15, wherein the spool has first and second ends, and wherein the first and second preloaded springs are located adjacent opposite ends of the spool.

21. The spool-type fluid control valve of claim 14, further comprised of a second electromagnetic coil, the spool being electromagnetically attracted to the second position by electrical excitation of the second electromagnetic coil.

22. The spool-type fluid control valve of claim 21, further comprised of a second preloaded spring configured to apply a second spring force to the spool biasing the spool towards the second position when the spool is at any of i) the first position, ii) the second position, and iii) anywhere between the first and second positions.

23. The spool-type fluid control valve of claim 22, wherein the fraction is less than approximately one half.

24. The spool-type fluid control valve of claim 22, wherein the fraction is in the range of approximately one fifth to approximately one fourth.

25. The spool-type fluid control valve of claim 14, wherein the spool has a zero nonmagnetic gap relative to the housing when the spool is in the first position.

26. A method of operating an electromagnetic actuator, comprising:
providing first and second magnetic members and a first electromagnetic coil, the first magnetic member being moveable relative to the second magnetic member between first and second positions;
electromagnetically attracting the first magnetic member to the first position by electrical excitation of the first electromagnetic coil;
compressing a preloaded spring only as the first magnetic member moves from a position, spaced from the first and second positions, to the first position;
storing energy in the preloaded spring as the spool compresses the preloaded spring; and,
returning the energy stored in the preloaded spring to the first magnetic member as the first magnetic member moves from the first position towards the second position.

27. The method of claim 26, further comprising returning the first magnetic member to the second position by electrical excitation of a second electromagnetic coil.

28. The method of claim 26, further comprising returning the first magnetic member to the second position by a return spring.

29. The method of claim 28, further comprised of preloading the return spring.

30. The method of claim 26, further comprised of maintaining the first magnetic member in the first position using a holding electrical current in the first electromagnetic coil.

31. The method of claim 26, wherein the position spaced from the first and second positions is closer to the first position than to the second position.

32. The method of claim 31, wherein the position spaced from the first and second positions is in the range of approximately one fifth to approximately one fourth of the way from the first position to the second position.

33. A method of operating a spool-type fluid control valve, comprising:
providing a magnetic spool, a magnetic spool valve housing and a first electromagnetic coil, the spool being moveable relative to the housing between first and second positions;
electromagnetically attracting the spool to the first position by electrical excitation of the first electromagnetic coil;
compressing a preloaded spring only as the spool moves from an intermediate position, spaced from the first and second positions, to the first position;
storing energy in the preloaded spring as the spool compresses the preloaded spring;
terminating electrical excitation of the first electromagnetic coil; and,
returning the energy stored in the preloaded spring to the spool as the spool moves from the first position towards the second position.

34. The method of claim 33, further comprising returning the spool to the second position by electrical excitation of a second electromagnetic coil.

35. The method of claim 33, further comprising returning the first magnetic member from the first position all the way to the second position by a return spring.

36. The method of claim 35, further comprised of preloading the return spring.

37. The method of claim 33, further comprised of maintaining the spool in the first position by continuously using a holding electrical current in the first electromagnetic coil.

38. The method of claim 33, wherein the intermediate position is closer to the first position than to the second position.

39. The method of claim 38, wherein the intermediate position is in the range of approximately one fifth to approximately one fourth of the way from the first position to the second position.

40. The method of claim 33, further comprising providing i) an instantaneous step increase in effective spring force, biasing the spool towards the second position, when the spool reaches the intermediate position from the second position and ii) an instantaneous step decrease in effective spring force, biasing the spool towards the second position, when the spool reaches the intermediate position from the first position.
